(19) United States
(12) Patent Application Publication
(10) Pub. No.: US 2008/0306982 A1
(43) Pub. Date: Dec. 11, 2008

(54) SYSTEM AND METHOD FOR GENERATING REPORTS ON REAL PROPERTY AND SURROUNDINGS

(76) Inventor: Kirk Moudy, Middleburg, FL (US)

Correspondence Address: MARK YOUNG, P.A., 12086 FORT CAROLINE ROAD, UNIT 202, JACKSONVILLE, FL, 32225, US

(21) Appl. No.: 11/760,214

(22) Filed: Jun. 8, 2007

(51) Int. Cl. G06F 17/00

(52) U.S. Cl. 707/102

(57) ABSTRACT

A system and method for generating reports on real property and surroundings, and more particularly, to a system and method for producing and maintaining a network accessible searchable database of property information that enables production of reports that provide a holistic view of the property includes the steps of receiving a user request for information that relate to a particular property; identifying records in a database that relate to the particular property, said records containing data relating to at least two of fire incident data, engineering data, property appraiser data, clerk of court data, building department data, multiple listing service data, US census data, national sex offender data and sheriff data, and then displaying an electronically displayable property report containing the identified records and said data for the property. Records may be updated and added to the database. Data in the report that satisfies a determined alert condition (e.g., exceeds a threshold) may be identified, such as by highlighting, underscoring, emboldening or other attention getting device.

### FIELD OF THE INVENTION

This invention generally relates to a system and method for generating reports on real property and surroundings, and more particularly, to a system and method for producing and maintaining a network accessible searchable database of property information that enables production of reports that provide a holistic view of the property.

### BACKGROUND

Tools for evaluating available real properties are generally limited to searchable databases and lists containing brief descriptions, photos and basic sales information. Upon processing a query, a linear result list is generated. In some cases, the list may be sorted by categories such as selling price, zip code or other available field of information. To access more information about a property and its surrounds, the agent, prospective buyer, or other person performing research must conduct additional searches and navigate through a series of websites and web pages, clicking several times, spawning new web pages to view maps, school district information, tax data, and other information that an interested agent, prospective buyer, or other person may need to assess the property. Even then, however, the information would not available in an integrated report. Furthermore, the process is tedious and difficult to reproduce.

Prospective purchasers would prefer to avoid acquiring real properties in problematic situations. Non-limiting examples of such problematic situations include liens, failed inspections, improper permitting for work performed, economically disadvantaged and crime-ridden surroundings, nearby sexual offenders, and fire incidents, as described herein. Most people shopping for a home would appreciate the value in knowing whether such problems exist for a given property as early in the evaluation process as possible.

Concomitantly, lenders rely on property value determinations, frequently involving a human appraiser, in order to determine how much money to lend for a particular piece of property. In recent years, various types of automated valuation models have been developed in an attempt to automate the process of property value estimation. However, such models are not always accurate, since there are many factors that may affect a valuation but do not go into the model. For instance, conventional models do not account for social and economic conditions in the area in which the property is located. A number of economic conditions such as household incomes, interest rates, and unemployment rates in an area may impact future home prices. Likewise, crime and foreclosures affect values. Yet, those conditions are typically not factored into conventional valuation models. Such deficiencies can lead to costly errors.

What is needed is a system and method for producing and maintaining a network accessible searchable database of property information that enables production of reports that provide a holistic view of the property, including social and economic conditions in the area in which the property is located, as well as property conditions such as liens, failed inspections, improper permitting for work performed, deed restrictions, and fire/water incidents. The invention is directed to overcoming one or more of the problems and solving one or more of the needs as set forth above.

### SUMMARY OF THE INVENTION

To solve one or more of the problems set forth above, in an exemplary implementation of the invention, in one embodiment, a method for generating and displaying information relating to a property according to principles of the invention, includes the steps of: receiving a user request for information that relate to a particular property; identifying records in a database that relate to the particular property, said records containing data relating to at least two of fire/water incident data, engineering data, property appraiser data, clerk of court data, building department data, multiple listing service data, US census data, national sex offender data, sheriff data, and then displaying an electronically displayable property report containing the identified records and said data for the property. Records in the database that relate to the particular property may be updated to reflect changes in data relating to at least one of fire/water incident data, engineering data, property appraiser data, clerk of court data, building department data, multiple listing service data, US census data, national sex offender data, and sheriff data. Records may also be added for new properties. Data in the report that satisfies a determined alert condition (e.g., exceeds a threshold) may be identified, such as by highlighting, underscoring, emboldening or other attention getting device.

In another aspect of an exemplary implementation of the invention, a property information system is provided, which includes various modules and units which perform the above-described functions. These modules and units may be implemented as hardware and/or software and/or firmware to substantially perform the functions explained above. The various functions of the different components can be combined or segregated in any manner.

### BRIEF DESCRIPTION OF THE DRAWINGS

The foregoing and other aspects, objects, features and advantages of the invention will become better understood with reference to the following description, appended claims, and accompanying drawings, where:

FIG. 1 shows a high-level block diagram of an exemplary system for accessing a searchable database of property information that enables production of reports that provide a holistic view of the property according to principles of the invention; and

FIG. 2 shows a high-level block diagram of an exemplary system for producing and maintaining a network accessible searchable database of property information that enables production of reports that provide a holistic view of the property according to principles of the invention; and

FIG. 3 shows a high-level flowchart of an exemplary method for gathering data to produce and maintain a network accessible searchable database of property information that enables production of reports that provide a holistic view of the property according to principles of the invention; and

FIG. 4 shows a high-level flowchart of an exemplary method for gathering data from an online source such as a website to produce and maintain a network accessible searchable database of property information that enables production of reports that provide a holistic view of the property according to principles of the invention; and

FIG. 5 shows a high-level flowchart of an exemplary method for searching and retrieving data from a network accessible searchable database of property information that enables production of reports that provide a holistic view of the property according to principles of the invention; and

FIG. 6 shows a high-level flowchart of an exemplary method for searching and retrieving data from a network accessible searchable database of property information that enables production of reports that provide a holistic view of the property according to principles of the invention.

Those skilled in the art will appreciate that the figures are not intended to illustrate every embodiment of the invention. The invention is not limited to the exemplary embodiments depicted in the figures or the system components, arrangement of components, steps, or arrangement of steps shown in the figures.

### DETAILED DESCRIPTION

Referring to the Figures, in which like components and steps are indicated with the same reference numerals, various block diagrams and flowcharts illustrating systems and methodologies according to principles of the invention are shown. The invention provides a system and method for producing and maintaining a network accessible searchable database of property information that enables production of reports that provide a holistic view of the property, including social and economic conditions in the area in which the property is located, as well as property conditions such as liens, failed inspections, improper permitting for work performed, deed restrictions, and fire/water incidents.

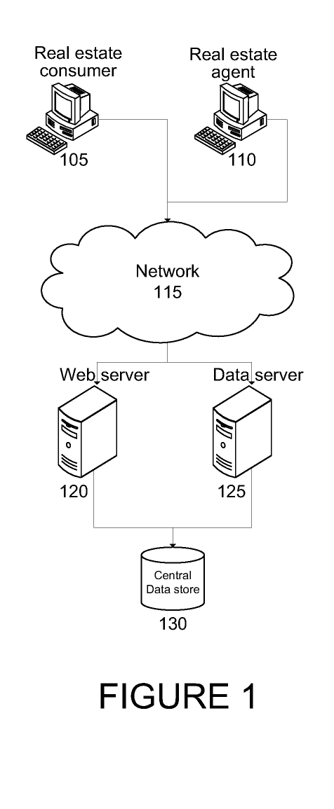

Referring to FIG. 1, a high-level block diagram of an exemplary system for accessing a searchable database of property information that enables production of reports that provide a holistic view of the property according to principles of the invention is conceptually illustrated. A web server 120 and database server 125 host software for storing data and performing functions according to the invention. Users (e.g., individuals seeking property information) using computing devices 105-110 access one or more of the servers 120, 125 to perform various functions, such as performing searches and obtaining search results and reports. Access to the servers 120, 125 by the plurality of users 105-110 is preferably via one or more data communications networks, which may include the Internet 115.

An exemplary server 120, 125 is comprised of a computer system, having a bus for communicating information, a central processing unit (CPU), a read only memory (ROM), a random access memory (RAM), a mass storage device, and communications equipment. The storage device may include a hard disk, CD-ROM drive, DVD drive, tape drive, memory (e.g., RAM, ROM, Compact Flash RAM, PCMCIA RAM) and/or other storage equipment. An input device such as a keyboard, touch sensitive screen, a pointing device (e.g., a computer mouse, touch pad or joystick) and the like may also be provided. Software such as network operating system software may be stored on and executable on the server. These elements are typically included in many computer servers. Indeed, the aforementioned servers are intended to represent a broad category of computer systems capable of functioning as a computer server and hosting application software for network access and use and database management in accordance with the present invention. Of course, the servers 102, 125 may include fewer, different and/or additional elements, functioning as single servers or as a distributed system, provided they are capable of performing functions in accordance with the present invention.

The servers 120, 125 host (i.e., provides clients with access to) information, documents and software needed to provide functionality and enable performance of methodologies in accordance with an exemplary embodiment of the invention. For example, the servers 120, 125 may include web page information and documents (e.g., scripts, HTML and XML code), applets and application software, which manage subscriber access and use, processes transactions and manage databases for subscriber data.

The Web server 120 is responsible for accepting HTTP requests from client Web browsers, and serving the requester HTTP responses along with optional data contents, which usually are Web pages such as HTML documents and linked objects (images, etc.). The HTTP response typically consists of an HTML document, but can also be a raw text file, an image, or some other type of script, document, applet, file, message or information. The Web server may have the capability of logging detailed information, about client requests and server responses, to log files, allowing the Webmaster to collect statistics by running log analyzers on log files. Such statistics may be used for security monitoring and to optimize performance.

The database server 125 provides database services to other computer programs or computers. The server 125 runs a database management system (DBMS) which provides functionality, namely, managing and querying the database 130. The database 130 is a structured collection of records or data that is stored in a computer so that the database management system can consult it to answer queries.

A plurality of users directly or indirectly access the servers 120, 125 using compatible computing devices 105-110 with network connectivity. By way of example, such devices 110-120 may include personal computers, personal digital assistants or any similarly equipped electronic computing devices. Although two user computers 105-110 are shown for illustrative purposes, any number of user computers may be used in accordance with the invention. Additionally, various forms of network connectivity may be used by the user computers 105-110 to access one or more of the servers 120, 125. Subscriber system may include an operating system and a web browser configured to process data sent by the server system.

Those skilled in the art will appreciate that a system according to the invention can utilize many different types of communications networks. For example, a proprietary Wide Area Network (WAN) or a public WAN such as the Internet may be used. These networks typically employ various protocols such as the HyperText Transfer Protocol (HTTP), Extensible Markup Language (XML), and Transfer Control Protocol/Internet Protocol (TCP/IP) to communicate information between remote computer systems. A system according to the present invention may also utilize wireless networks, including those utilizing Global System for Mobile (GSM), Code Division Multiple Access (CDMA) or Time Division Multiple Access technology, and the Wireless Application Protocol (WAP). A system according to the invention may utilize any or any combination of, such communications networks and new network technologies hereafter developed.

A firewall may be located between each server 102, 125 and the network 115 to protect against corruption, loss, or misuse of data. The firewall limits access by the user computers 105, 110 and prevents corruption of data. Thus, the user computers 105, 110 may access and receive only data that is deemed necessary and authorized according to firewall settings. The firewall may be integrated within the servers 120, 125 as software or a hardware component, or constitute another system component, or reside as a standalone component.

It should be noted that the property information system in accordance with the embodiment of the present invention is illustrated and discussed herein as having various modules and units which perform particular functions. It should be understood that these modules and units, including the web/file server and database(s), are merely schematically illustrated based on their function for clarity purposes, and do not necessarily represent specific hardware or software. In this regard, these modules, units and other components may be hardware and/or software implemented to substantially perform their particular functions explained herein. The various functions of the different components can be combined or segregated as hardware and/or software modules in any manner, and can be useful separately or in combination. Thus, the present invention as schematically embodied in FIG. 1 should not be construed to limit the system of the present invention, but be understood to merely be a schematic example.

The processes, functions and/or algorithms described herein are implemented in hardware, software or a combination of software and hardware in one embodiment. The software comprises computer executable instructions encoded in a computer readable media. Further, such functions correspond to modules, which are software, hardware, firmware, or any combination thereof. Multiple functions are performed in one or more modules as desired, and the embodiments described are merely examples. The software is executed on a digital signal processor, application-specific integrated circuit, microprocessor, or other type of processor operating on a system, such as a personal computer, server, a router, or other device capable of processing data including network interconnection devices. Some embodiments may implement the functions in two or more specific interconnected hardware modules or devices with related control and data signals communicated between and through the modules, or as portions of an application-specific integrated circuit. Thus, the exemplary process flow is applicable to software, firmware, and hardware implementations.

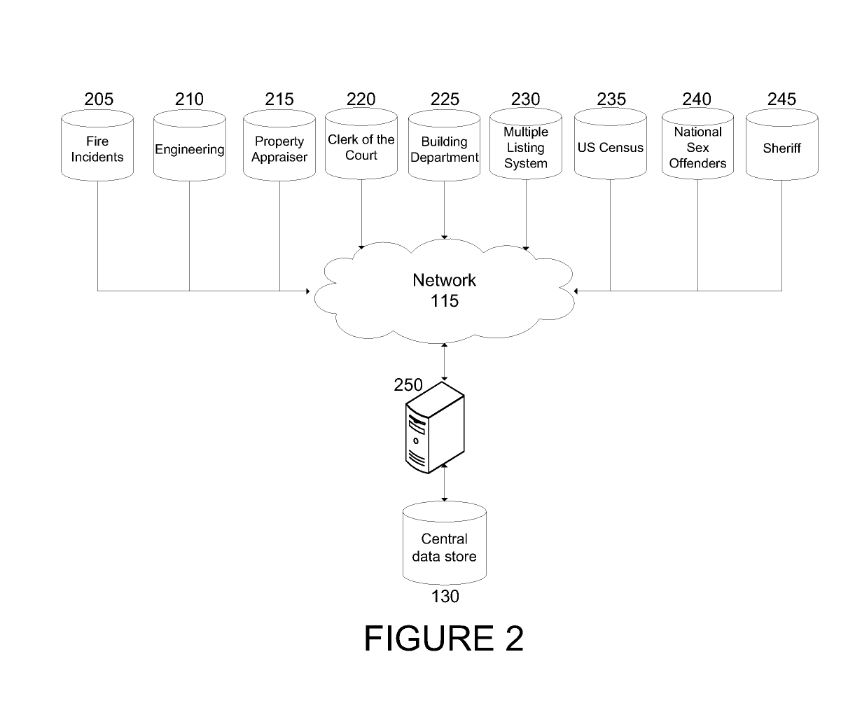

Database 130 contains a comprehensive collection of property and other relevant data arranged, organized, indexed and/or retrievable based on address or other identifying criteria. An administrator of the system acquires the data from a variety of data suppliers 205-245, as shown in FIG. 2. Each item of data acquired and entered into central database 130 is associated with a particular address, geographical region or other identifier. When a report is requested as discussed herein, available records indexed by the same address, geographical region or other identifier are selected.

The database 130 may be any conventional database capable of effectively storing collections of records in an organized accessible manner to permit efficient easy access to desired pieces of data, i.e. one or more records, for example, associated with a particular property, using appropriate database management system software. The information stored in central database 130 may include, for example, fire incident data 205, engineering data 210, property appraiser data 215, clerk of court data 220, building department data 225, multiple listing service (MLS) data 230, US census data 235, national sex offender data 240 and sheriff data 245, as well as any other available data relevant to the purchase, valuation or assessment of a property and/or a surrounding area. The data may be obtained and updated online or off-line.

The exemplary system populates the database 130 with fire incident data 205. Fire departments maintain public records of fires, floods, mass casualties and hazardous materials incidents, collectively referred to herein as fire incidents. Such records typically include the date, address and a summary of the incident including damage, injuries and causation. All such records are entered into the database 130 and assigned unique id to identify the record. The process for entering/updating a fire incident record starts with determining if the address is currently in the database. If the address is in the database, the address is compared to determine if the fire incident data for the address has changed. Each item that has changed is copied to a history table and then the current record is updated. If the address is not in the database 130, it is assigned a unique identifier and added to the database 130 along with the fire incident data.

The exemplary system populates the database 130 with engineering data 210. Governmental engineering departments typically maintain information on benchmark datum, right of way permitting, project tracking on government projects, civil plan review status, land development and city standards, specifications, standard details and contract documents for work within the jurisdiction. Building plan data and images are imported to the database 130 and later the property and permit are joined to the record. The process for entering building plans starts with entering the text that has been extracted out of the document for indexing into the database 130, where a unique id is created to represent it. Next the scanned images of the document are stored in the database 130 along with the unique id for the text creating the association between the text and the images for each document. After the building plan records are entered into the database 130 the indexed text data is used to link the building plan record back to the parcel. This is accomplished by using the parcel address, county's parcel id, legal description, or permit number to match the parcel details obtained from the different county's property appraiser data.

The exemplary system populates the database 130 with property appraiser data 215. Property appraiser offices typically maintain an inventory of every parcel of property in a jurisdiction and corresponding ownership information, market values and tax rates. All property records are entered into the database 130 and assigned unique id to identify the record. The process for entering/updating a property record starts with determining if the address is currently in the database. If the address is in the database, the address is compared to determine if any of the attributes of the property (number of dwellings, size of dwelling, and features of dwelling . . . ) have changed. Each item that has changed is copied to a property history table and then the current record is updated. If the address is not in the database 130, it is assigned a unique identifier and added to the database 130.

The exemplary system populates the database 130 with clerk of court data 220. Clerk of Court Offices maintain records of judgments, liens, mortgages, deeds, easements, restrictions and death certificates. Clerk of Court data may include data and images (i.e., image files). The data is imported and images relevant to a property are downloaded and added to the database 130. The process for entering a file (e.g., image file) from the clerk of the court starts with entering text that has been extracted out of the file for indexing into the database, where a unique id is created to represent it. Next the scanned images of the file are stored in the database along with the unique id for the text creating the association between the text and the images for each document. After the clerks records are entered into the database the indexed text data is used to link the clerk record back to the parcel. This may accomplished by using either the parcel address, county's parcel id or legal description to match the parcel details obtained from the different county's property appraiser data.

The exemplary system populates the database 130 with building department data 225. Building departments maintain records of building plans, permits for residential and commercial construction, and inspections according to the local building code and ordinances. Permit data is imported into the database 130 and later the corresponding property is associated to the permit data. The process for entering/updating a permit starts with determining if the permit is in the database 130 or not. If the permit is in the database 130 the permit's values are compared and if the values are different the record is updated. After all permits for a county are processed, permits are assigned to a parcel. Each permit address is used to query the parcel's database 130 to determine if there is a match. If a match is found, the unique id that identifies the parcel in the database 130 is returned and added to the permit's record, creating an association. If a match is found that is not an exact match (e.g., the street number and name are correct but the type of street is spelled out and not abbreviated) but is very close, the unique parcel id will be returned and added to the permit's record creating the association. If a questionable match is found (e.g., the street number is correct but the street name is misspelled and or the type of street is spelled out and not abbreviated) the records unique id and all possible matches will be saved to a holding table to be reviewed by a person to make the final decision.

The exemplary system populates the database 130 with MLS data 230. The Multiple Listing Service (MLS) (also Multiple Listing System or Multiple Listings Service) is a database which allows real estate brokers representing sellers under a listing contract to widely share information about properties with real estate brokers who may represent potential buyers or wish to cooperate with a seller's broker in finding a buyer for the property. The MLS combines the listings of all available properties that are represented by brokers who are both members of that MLS system and of NAR or CREA, (the National Association of Realtors in the US or the Canadian Real Estate Association). The purpose of the MLS is to enable the efficient distribution of information so that, when a real estate agent is introduced to a potential home buyer, he/she may search the MLS system and retrieve information about all homes for sale in a given area or price range, whether under a listing contract by that agent's brokerage or by all participating brokers. The process of entering/updating the Multiple Listing System records starts with entering all records that are not found by comparing addresses in the database 130 with a unique id. Records that are found in the database 130 are compared to the new records, and if they differ, the database 130 is updated with the new values

The exemplary system populates the database 130 with census data 235. The United States Census Bureau (officially Bureau of the Census as defined in Title 13 U.S.C. §11) is a part of the United States Department of Commerce. It is the government department responsible for the United States Census. The Constitution of the United States directs that the population be enumerated at least once every ten years (through the U.S. Census), and each state's number of Federal Representatives in Congress determined accordingly. The Census Bureau is in mandated with fulfilling these obligations: the collecting statistics about the nation, its people, and economy. Thus, the Census Bureau's leading source of quality data about the nation, its people and economy.

The exemplary system populates the database 130 with sex offender data 240. The National Sex Offender Public Registry, coordinated by the Department of Justice, is a cooperative effort between the state agencies hosting public sexual offender registries and the federal government. The registry is a search tool allowing a user to submit a single national query to obtain information about sex offenders. The process of entering/updating sex offender data starts with entering all sex offenders and associated addresses that are not already in the database 130. Next the name-address records examined, and if they differ, the records are updated. After all records are assigned a unique id and stored or updated in the database 130 the address is used to get the unique id from the parcels database 130 creating the association between the sex offender with the property appraiser record. Sex offenders that are listed in the database 130 that no longer are associated with a prior address will have the parcel's unique id removed so that the offender is no longer associated with that parcel.

The exemplary system populates the database 130 with sheriff data 210. Sheriff's offices maintain inmate, sex offender and civil service of process records.

The exemplary system may, optionally, populate the database 130 with fire incident data 205. The process of entering the incidents logged by a fire department starts with determining what incidents are not currently in the database 130. Next the records not in the database 130 are entered and then the address is looked-up against the property appraiser data. When the address is found, the unique ID is returned and added to the fire incident report record to provide a reference back to the property.

A server 250, which may be the same as data server 125, web server 120, or a different server, host software for populating the database 130 with data and maintaining the database 130. Access to the server 250 is preferably via one or more data communications networks, which may include the Internet 115. The exemplary server 250 is comprised of a computer system, having a bus for communicating information, a central processing unit (CPU), a read only memory (ROM), a random access memory (RAM), a mass storage device, and communications equipment. The storage device may include a hard disk, CD-ROM drive, DVD drive, tape drive, memory (e.g., RAM, ROM, Compact Flash RAM, PCMCIA RAM) and/or other storage equipment. An input device such as a keyboard, touch sensitive screen, a pointing device and the like may also be provided. Software such as network operating system software may be stored on and executable on the server. These elements are typically included in many computer servers. Indeed, the aforementioned servers are intended to represent a broad category of computer systems capable of functioning as a computer server and hosting application software for network access and use and database management in accordance with the present invention. Of course, the servers 250 may include fewer, different and/or additional elements, functioning as single servers or as a distributed system, provided they are capable of performing functions in accordance with the present invention.

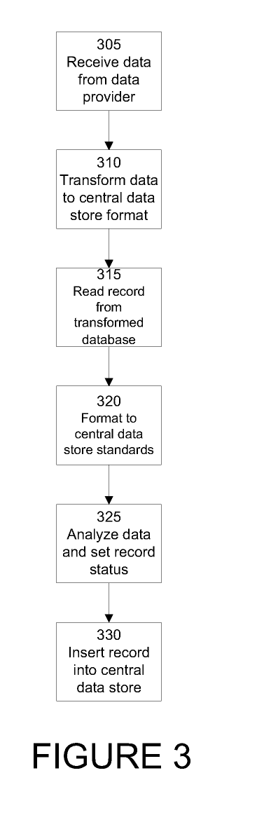

Referring now to FIG. 3, a high-level flowchart of an exemplary method for gathering data to produce and maintain the database 130 is conceptually shown. As an initial step 305, data is received from a data source 205-245. The data is then transformed to a format compatible with the database, as in step 310. By way of example and not limitation, the data may be supplied on computer readable medium and processed using server 250. Data transformation converts data from the source data format into destination data compatible with the database 130. Records are then read from the transformed database, as in step 315, and formatted according to database standards, as in step 320. Next the data is analyzed and the record status is set, as in step 325. Subsequently, the record is inserted in the database 130.

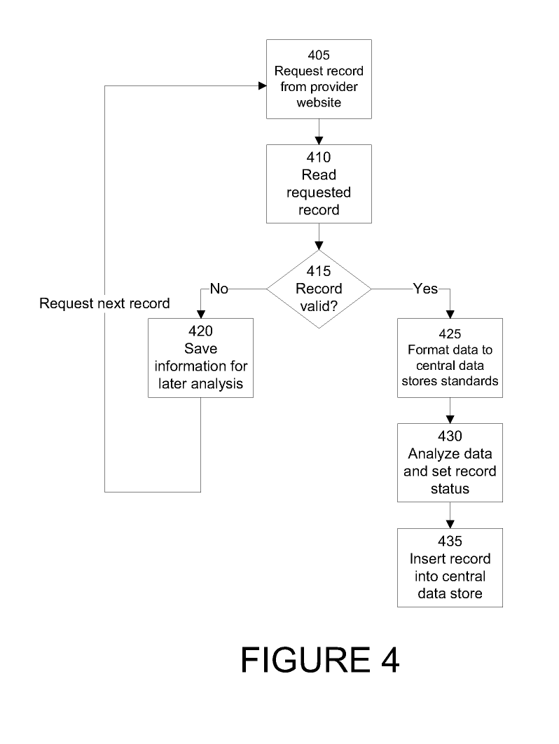

Referring now to FIG. 4, a high-level flowchart of an exemplary method for gathering data from an online source, such as a website, to produce and maintain the network accessible searchable database of property information is conceptually shown. A record is requested from a provider's 205-245 online resource (e.g., a website), as in step 405. The requested record is then read 410 and validated 415, before being processed for populating the database 130. If the record fails validation 415, it may be saved for subsequent analysis, as in step 420. By way of example and not limitation, the data may be supplied to and processed using the server 250. The validated records are then formatted according to database standards, as in step 425. Next the data is analyzed and the record status is set, as in step 430. Subsequently, the record is inserted in the database 435.

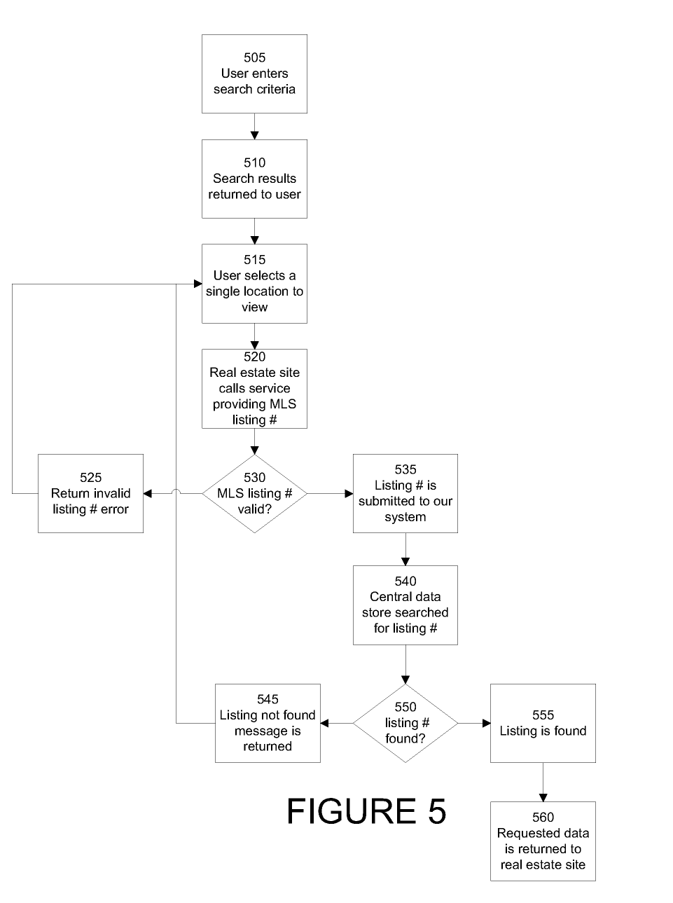

Referring now to FIG. 5, a high-level flowchart of an exemplary method for searching and retrieving data from a third party (e.g., real estate agency) website is shown. An user enters search criteria in step 505. By way of example and not limitation, the search criteria may be an address, plat identifier, zip code or some other criterion, or a combination of search criteria. The results are then returned to the agent, as in step 510. The agent may then select a property, from the search results, to view, as in step 515. Then an MLS service is accessed for a listing number, as in step 520. If the listing number is valid 530, the listing number is submitted to a system according to the principles of the invention and the database 130 is searched for the listing number, as in steps 535 and 540. Valid listing numbers correspond to properties on the real estate agency's site. Otherwise, an invalid listing error is returned, as in step 525. If the listing number is found, requested data is returned for the property, as in steps 550-560. Thus, according to various embodiments, the present subject matter provides for the integration with third party of real-time MLS datasets directly into the system hereof, along with stored data for a property location. If the listing number is not found, a listing not found message is returned, as in step 545.

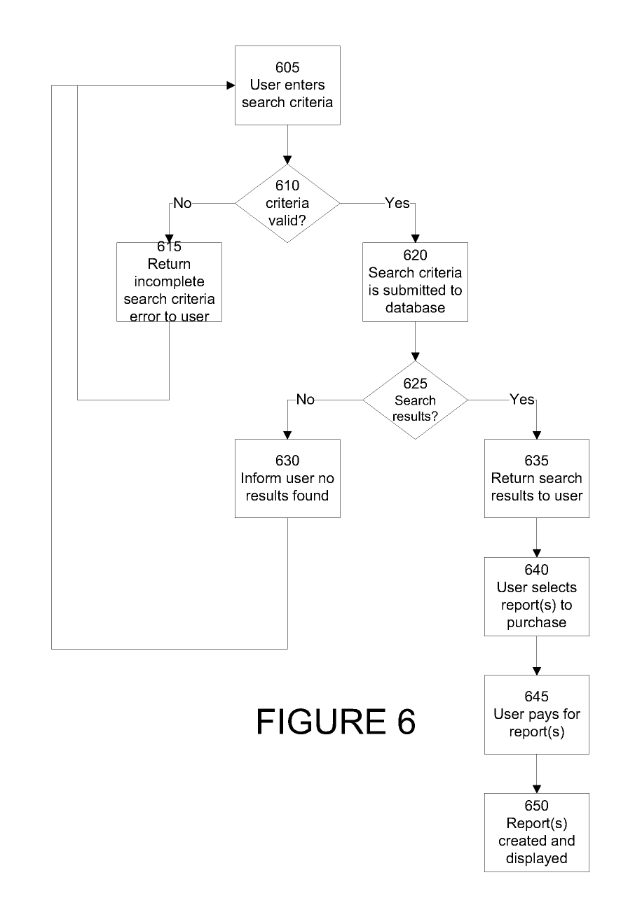

Referring now to FIG. 6, a high-level flowchart of an exemplary method for a user to search and retrieve data from the database is shown. The user enters search criteria in step 605. By way of example and not limitation, the search criteria may be an address, plat identifier, zip code or some other criterion, or a combination of search criteria. Once a user enters appropriate search criteria, e.g., an address or geographic area with suitable properties, further detail about the property or area can be obtained from the database 130. The system analyzes the search criteria to determine if it is valid, as in step 610. Incomplete search criteria triggers an error message, as is step 615. Valid search criteria is submitted to the DBMS, as in step 620. If the DBMS receives results based on the search criteria, the results are then returned to the user, as in step 635. The user may then select a report to obtain (e.g., purchase) as in step 640. Upon payment, such as by credit card, as in step 645, the report is created and/or displayed as in step 650. If the DBMS receives no results based on the search criteria, a “no results found” message is returned to the user, as in step 630.

The system may be implemented using various modules, each module being one or more programs and/or hardware configured to perform desired functions. A property report module, which may reside on the server 125, functions to access database 130 and retrieve the appropriate records associated, for example, with a particular property upon the request by a user. Thus, the module includes the appropriate software necessary to select the appropriate property records from the database 130 based on a particular request, i.e. property. The property report module may further be adapted to arrange and organize the information in a manner appropriate for further data processing and/or display.

A user interface module is adapted to utilize the information provided by the property report module to generate a user interface for delivery to output device of a user terminal 105, 110. The user interface module may reside on the web server 120 or the data server 125. The user interface module may be in the form of a file server with appropriate software capable of generating particular electronically displayable files for delivery to, and display by, an output device of a user terminal 105, 110. Alternatively, the electronically displayable files may be stored in a separate file server or may reside on a remote server to which the system is connected. A communications managing module is adapted to manage communications and interactions between the system and its various components, and with the various terminals via the network 115.

Advantageously, a system and method according to principles of the invention provides a holistic view of houses and neighborhoods including fire/water incident data 205, engineering data 210, property appraiser data 215, clerk of court data 220, building department data 225, multiple listing service (MLS) data 230, US census data 235, national sex offender data 240 and sheriff data 245, as well as other possible available data relevant to the purchase, valuation or assessment of a property and/or a surrounding area. A report containing such data for a location would reveal, fire incidents for the property and surrounding areas, indicating risks. Such a report would also reveal engineering data, including nearby road construction and other public projects that may affect traffic. Such a report would also reveal government appraisal and tax information for a property and its surroundings. Any mortgages, liens, encumbrances, legal proceedings, deeds, easements, covenants and restrictions would also be included from clerk of court data. Building permits would reveal past and present construction for the property and surrounding properties. MLS data includes information about all homes for sale in a given area and price range. Census data includes population and socioeconomic data for a property and its surrounding area. Sex offender data would reveal any nearby felons registered as sex offenders. Sheriff's office data would reveal legal proceeding records pertaining to the property and its surroundings. A report containing the aforementioned data would provide a user a comprehensive view of a property its surroundings, and their pros and cons.

In another embodiment, reported data that may cause a user concern or that poses a potentially serious risk may be automatically highlighted (e.g., highlighted, underscored, emboldened) in the report. Such data may include sexual predators within a determined area (e.g., a radial distance from a property, a town, or a zip code) a determined number of foreclosures within a determined area, recent fire incidents, liens and mortgages, pending legal action involving a property and the like. Such data is referred to herein as risk data.

No other known system or method combines such data into a database and makes the data available in report format for a user interested in evaluating a property and its surroundings. The only known alternative is for a user to inefficiently research the property using several distinct, separate, unrelated data sources, several of which may be difficult to locate and cumbersome to navigate, and may not be readily searchable online. Then the user must sift through the research results and compile relevant data to form a report. Advantageously, a system and method according to principles of the invention saves a user much time and resources, facilitates informed decision-making, and provides a consistent comprehensive framework for comparing various properties and their surroundings and providing a holistic view of a property.

Those skilled in the art will appreciate that the names chosen for data sources, e.g., organization names and database names, are used for reference convenience only and not to limit the scope of the invention. Thus, for example, fire incident data is used herein to refer to data regarding fires, floods, mass casualties and/or hazardous materials incidents, without regard to the name of the data source or the organization from which it is obtained. The same holds true for engineering data, property appraiser data, clerk of court data, building department data, multiple listing service data, US census data, national sex offender data and sheriff data. Each refers to a certain types of data as described above, regardless of the name of the data source or the organization from which it is obtained.

While exemplary embodiments of the invention have been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact configuration and operation shown and described, and accordingly, all suitable modifications and equivalents are intended to fall within the scope of the invention as claimed.

What is claimed is:

1. A method for generating and displaying information relating to a property comprising the steps of: receiving a user request for information that relate to a particular property; identifying records in a database that relate to the particular property, said records containing data relating to at least two of fire incident data, engineering data, property appraiser data, clerk of court data, building department data, multiple listing service data, US census data, national sex offender data and sheriff data, and then displaying an electronically displayable property report containing the identified records and said data for the property.

2. The method of claim 1, wherein said data relating to at least two of fire incident data, engineering data, property appraiser data, clerk of court data, building department data, multiple listing service data, US census data, national sex offender data and sheriff data, includes fire incident data.

3. The method of claim 1, wherein said data relating to at least two of fire incident data, engineering data, property appraiser data, clerk of court data, building department data, multiple listing service data, US census data, national sex offender data and sheriff data, includes engineering data.

4. The method of claim 1, wherein said data relating to at least two of fire incident data, engineering data, property appraiser data, clerk of court data, building department data, multiple listing service data, US census data, national sex offender data and sheriff data, includes property appraiser data.

5. The method of claim 1, wherein said data relating to at least two of fire incident data, engineering data, property appraiser data, clerk of court data, building department data, multiple listing service data, US census data, national sex offender data and sheriff data, includes clerk of court data.

6. The method of claim 1, wherein said data relating to at least two of fire incident data, engineering data, property appraiser data, clerk of court data, building department data, multiple listing service data, US census data, national sex offender data and sheriff data, includes building department data.

7. The method of claim 1, wherein said data relating to at least two of fire incident data, engineering data, property appraiser data, clerk of court data, building department data, multiple listing service data, US census data, national sex offender data and sheriff data, includes multiple listing service data.

8. The method of claim 1, wherein said data relating to at least two of fire incident data, engineering data, property appraiser data, clerk of court data, building department data, multiple listing service data, US census data, national sex offender data and sheriff data, includes US census data.

9. The method of claim 1, wherein said data relating to at least two of fire incident data, engineering data, property appraiser data, clerk of court data, building department data, multiple listing service data, US census data, national sex offender data and sheriff data, includes national sex offender data.

10. The method of claim 1, wherein said data relating to at least two of fire incident data, engineering data, property appraiser data, clerk of court data, building department data, multiple listing service data, US census data, national sex offender data and sheriff data, includes sheriff data.

11. The method of claim 1, wherein said data relating to at least two of fire incident data, engineering data, property appraiser data, clerk of court data, building department data, multiple listing service data, US census data, national sex offender data and sheriff data, includes fire incident data and property appraiser data.

12. The method of claim 1, further comprising a step of updating records in the database that relate to the particular property to reflect changes in data relating to at least one of fire incident data, engineering data, property appraiser data, clerk of court data, building department data, multiple listing service data, US census data, national sex offender data and sheriff data.

13. The method of claim 1, further comprising a step of adding new records to the database that relate to a new property.

14. The method of claim 1, further comprising a step of identifying data in the report that satisfy a determined alert condition.

15. A method for generating and displaying information relating to a property comprising the steps of: receiving a user request for information that relate to a particular property; identifying records in a database that relate to the particular property, said records containing data relating to at least two of fire incident data, engineering data, property appraiser data, clerk of court data, building department data, multiple listing service data, US census data, national sex offender data and sheriff data, and then displaying an electronically displayable property report containing the identified records and said data for the property; wherein said data relating to at least two of fire incident data, engineering data, property appraiser data, clerk of court data, building department data, multiple listing service data, US census data, national sex offender data and sheriff data, includes fire incident data and engineering data.

16. The method of claim 15, wherein said data relating to at least two of fire incident data, engineering data, property appraiser data, clerk of court data, building department data, multiple listing service data, US census data, national sex offender data and sheriff data, includes property appraiser data and clerk of court data.

17. The method of claim 16, wherein said data relating to at least two of fire incident data, engineering data, property appraiser data, clerk of court data, building department data, multiple listing service data, US census data, national sex offender data and sheriff data, includes building department data.

18. The method of claim 17, wherein said data relating to at least two of fire incident data, engineering data, property appraiser data, clerk of court data, building department data, multiple listing service data, US census data, national sex offender data and sheriff data, includes multiple listing service data.

19. The method of claim 18, wherein said data relating to at least two of fire incident data, engineering data, property appraiser data, clerk of court data, building department data, multiple listing service data, US census data, national sex offender data and sheriff data, includes US census data.

20. The method of claim 19, wherein said data relating to at least two of fire incident data, engineering data, property appraiser data, clerk of court data, building department data, multiple listing service data, US census data, national sex offender data and sheriff data, includes national sex offender data and sheriff data.
